(19) United States
(12) Patent Application Publication
(10) Pub. No.: US 2016/0153337 A1
(43) Pub. Date: Jun. 2, 2016

(54) ENGINE SYSTEM HAVING TURBOCHARGER

(71) Applicant: Hyundai Motor Company, Seoul (KR)

(72) Inventors: Jong Il PARK, Seoul (KR); Dong Hee HAN, Seoul (KR); Yoon Joo KIM, Yongin-si (KR); Kwanhee CHOI, Seoul (KR); Hyun Jun LIM, lncheon (KR); Joowon LEE, Gwangju-si (KR); Nahm Roh JOO, Yongin-si (KR)

(73) Assignee: Hyundai Motor Company, Seoul (KR)

(21) Appl. No.: 14/755,768

(22) Filed: Jun. 30, 2015

(30) Foreign Application Priority Data
Dec. 2, 2014 (KR) 10-2014-0170349

(51) Int. Cl. F01N 3/20; F02B 37/18; F02D 23/00

(52) U.S. Cl. CPC F01N 3/2066; F02D 23/00; F02B 37/183

(57) ABSTRACT

An engine system having a turbocharger may include a main exhaust line branched from one side of an exhaust manifold and exhausting an exhaust gas from a combustion chamber, a supplementary exhaust line branched from another side of the exhaust manifold and exhausting the exhaust gas from the combustion chamber, a first catalyst device disposed in the main exhaust line and reducing toxic material included in the exhaust gas, a turbine of a turbocharger disposed in the supplementary exhaust line and operated by flow energy of the exhaust gas, a second catalyst device disposed in a downstream side of the turbine and reducing toxic material included in the exhaust gas; and an exhaust route control valve disposed in the main exhaust line and controlling a route of the exhaust gas.

### CROSS-REFERENCE TO RELATED APPLICATION

The present application claims priority to Korean Patent Application No. 10-2014-0170349 filed Dec. 2, 2014, the entire contents of which is incorporated herein for all purposes by this reference.

### BACKGROUND OF THE INVENTION

1. Field of the Invention

The present invention relates to an engine system in which exhaust gas is recirculated by using a turbocharger for improving an engine output in a low speed range, increasing combustion efficiency, and improving exhaust gas quality.

2. Description of Related Art

In general, it is known that a diesel engine has lower fuel consumption than a gasoline engine and better efficiency than the gasoline engine. In general, the diesel engine displays efficiency in a range of 40% owing to a high compression ratio of the diesel engine.

Currently, in order to obtain a high output from the engine, the engine is additionally provided with a turbocharger and an intercooler.

The engine having the turbocharger applied thereto forces the exhaust gas or external air with a compressor in the turbocharger and supplies turbocharged air (high temperature compressed air) produced thereby to an engine.

However, the air that is rapidly compressed absorbs heat from the turbocharger and heat generated in a course of the compression so as to have a drop of density, resulting in poor charging efficiency. Therefore, the turbocharged air is cooled by using the intercooler to obtain high density, resulting in taking a lot of air into an engine combustion chamber, enabling high output.

Currently, meeting the exhaust gas control trend such as EURO 3 or EURO 4 of Europe, a variety of systems are suggested in which a portion of the exhaust gas containing CO, HC, NOx, and so on being exhausted from a turbo diesel engine is recirculated for reducing contents thereof further. Of the systems, typical is an Exhaust Gas Recirculation (EGR) system.

Along with this, research is underway on increasing output torque while reducing fuel consumption in medium to low speed ranges of engine RPM in the engine having the turbocharger, and a research is also underway for efficiently controlling the supply of the recirculated gas.

The above information disclosed in this Background section is only for enhancement of understanding of the background of the invention and therefore it may contain information that does not form the prior art that is already known in this country to a person of ordinary skill in the art.

### BRIEF SUMMARY

Various aspects of the present invention are directed to providing an engine system having a turbocharger that can reduce fuel consumption and increase output torque in a low/middle speed range and to providing an engine system having a turbocharger that can reduce thermal deformation of an exhaust route control valve disposed in an exhaust line, improve durability and sealing performance, and improve efficiency of the turbocharger by reducing back pressure of the turbocharger.

According to various aspects of the present invention, an engine system having a turbocharger may include a main exhaust line branched from one side of an exhaust manifold and exhausting an exhaust gas from a combustion chamber, a supplementary exhaust line branched from another side of the exhaust manifold and exhausting the exhaust gas from the combustion chamber, a first catalyst device disposed in the main exhaust line and reducing toxic material included in the exhaust gas, a turbine of a turbocharger disposed in the supplementary exhaust line and operated by flow energy of the exhaust gas, a second catalyst device disposed in a downstream side of the turbine and reducing toxic material included in the exhaust gas, and an exhaust route control valve disposed in the main exhaust line and controlling a route of the exhaust gas.

The exhaust route control valve may be disposed in a downstream side of the first catalyst device.

A third catalyst device may be disposed in the downstream side of the first catalyst device.

The main exhaust line and the supplementary exhaust line may be joined and form a single exhaust line.

A third catalyst device purifying the exhaust gas may be disposed in the single exhaust line.

The engine system may further include a main intake line supplying external air to an intake manifold, a supplementary intake line branched from an upstream side of the main intake line and joined to a downstream side of the main intake line, an intake route control valve disposed where the main intake line and the supplementary intake line are connected and controlling gas flowing in the main intake line, a compressor of the turbocharger disposed in the supplementary intake line and operated by the turbine of the turbocharger, and an intercooler disposed in a downstream side of the compressor of the turbocharger and cooling air compressed by the compressor.

A throttle valve controlling gas supply to the intake manifold may be disposed in an inlet of the intake manifold.

The main exhaust line and the supplementary exhaust line may not be joined and exhaust the exhaust gas to the outside, respectively.

The exhaust route control valve may be disposed in a downstream side of the first catalyst device.

A third catalyst device purifying the exhaust gas may be disposed between the exhaust route control valve and the first catalyst device of the main exhaust line.

The main exhaust line and the supplementary exhaust line may be connected to an outside, respectively, and exhaust the exhaust gas to the outside.

According to various aspects of the present invention, since an exhaust route control valve is disposed in the downstream side of a first catalyst device, thermal deformation by the exhaust gas having a high temperature is reduced, and sealing performance and durability are improved.

Further, since pipes and flanges for mounting the exhaust route control valve disposed in the main exhaust line can be moved to the downstream side of the main exhaust line, interference with a turbine of the turbocharger is not generated, and assembling characteristics and maintenance are improved.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram illustrating an exemplary engine system having a turbocharger according to the present invention.

FIG. 2 is a schematic diagram illustrating an exemplary engine system having a turbocharger according to the present invention.

FIG. 3 is a schematic diagram illustrating an exemplary engine system having a turbocharger according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

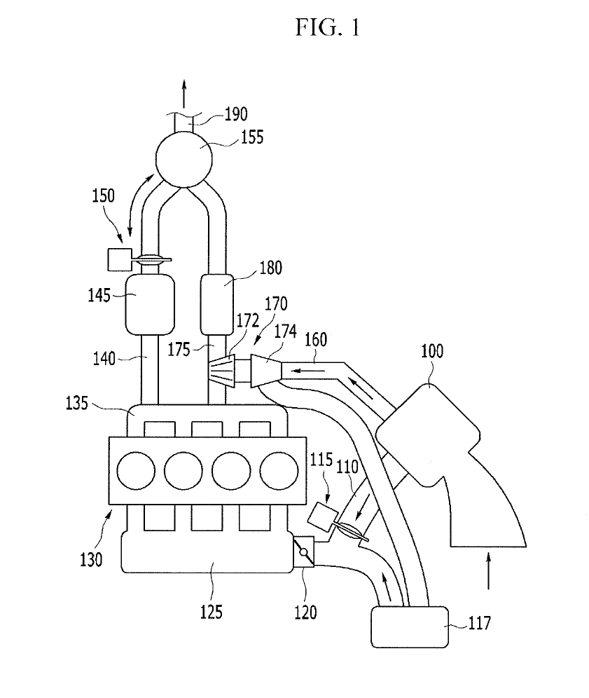

FIG. 1 is a schematic diagram illustrating an engine system having a turbocharger according to various embodiments of the present invention.

Referring to FIG. 1, an engine system according to various embodiments of the present invention includes an air cleaner 100, a main intake line 110, an intake route control valve 115, a throttle valve 120, an intake manifold 125, a supplementary intake line 160, a compressor 174 of a turbocharger 170, an intercooler 117, an engine 130, an exhaust manifold 135, a main exhaust line 140, a first catalyst device 145, an exhaust route control valve 150, a supplementary exhaust line 175, a turbine 172 of the turbocharger 170, a second catalyst device 180, and a third catalyst device 155.

The air cleaner 100, the intake route control valve 115, and the throttle valve 120 are sequentially disposed in the main intake line 110. The supplementary intake line 160 is branched from the air cleaner 100 disposed in the main intake line 110, and joined to the main intake line 110 between the intake route control valve 115 and the throttle valve 120.

The compressor 174 of the turbocharger 170 and the intercooler 117 are sequentially disposed in the supplementary intake line 160. The compressor 174 is connected to the turbine 172 of the turbocharger 170, and the turbine 172 and the compressor 174 are rotated with each other.

When an operation load of the engine 130 is less than a predetermined value, the intake route control valve 115 is closed, and external air supplied to the air cleaner 100 is supplied to the intake manifold 125 passing through the compressor 174, the intercooler 117, and the throttle valve 120.

When an operation load of the engine 130 is greater than the predetermined value, the intake route control valve 115 is opened, and the external air supplied to the air cleaner 100 is supplied to the intake manifold 125 passing through the intake route control valve 115 and the throttle valve 120.

The external air supplied to the intake manifold 125 is supplied to a combustion chamber of the engine 130 through each intake port. The external air is mixed with fuel in the combustion chamber, and the mixed gas is combusted in the combustion chamber. A combustion gas combusted in the combustion chamber is exhausted to the exhaust manifold 135 through an exhaust port.

The main exhaust line 140 is branched from one side of the exhaust manifold 135, and the supplementary exhaust line 175 is branched from the other side of the exhaust manifold 135. The end portion of the main exhaust line 140 and the supplementary exhaust line 175 are joined, and a single exhaust line 190 is formed.

The first catalyst device 145 and the exhaust route control valve 150 are sequentially disposed in the main exhaust line 140. The turbine 172 of the turbocharger 170 and the second catalyst device 180 are sequentially disposed in the supplementary exhaust line 175.

The third catalyst device 155 is disposed at a point where the main exhaust line 140 and the supplementary exhaust line 175 are joined.

When the operation load of the engine 130 is less than the predetermined value, the exhaust route control valve 150 is closed, and the exhaust gas is exhausted to the supplementary exhaust line 175. The exhaust gas flowing in the supplementary exhaust line 175 is exhausted to the outside passing through turbine 172 of the turbocharger 170, the second catalyst device 180, the third catalyst device 155, and the single exhaust line 190.

When the operation load of the engine 130 is greater than the predetermined value, the exhaust route control valve 150 is opened, and the exhaust gas is supplied to the main exhaust line 140. The exhaust gas flowing in the main exhaust line 140 is exhausted to the outside passing through the first catalyst device 145, the exhaust route control valve 150, the third catalyst device 155, and the single exhaust line 190.

The first catalyst device 145, the second catalyst device 180, and the third catalyst device 155 reduce toxic material, for example, HC, CO, and NOx, and trap particulate material included in the exhaust gas flowing in the main exhaust line 140 or the supplementary exhaust line 175.

According to various embodiments of the present invention, since the exhaust route control valve 150 is disposed in the downstream side of the first catalyst device 145, the exhaust route control valve 150 is operated at a relatively low temperature, and thereby durability of the exhaust route control valve 150 is improved. On the contrary, since the first catalyst device 145 is disposed near the exhaust manifold 135, light-off time (LOT) of a catalyst becomes short, and quality of the exhaust gas is improved.

Further, deformation of the exhaust route control valve 150 is reduced and sealing performance of the exhaust route control valve 150 is improved. Simultaneously, since the exhaust route control valve 150 does not interfere with the turbine 172 of the turbocharger 170 and a limit in securing installation space is reduced, assembly convenience and maintenance are improved.

In various embodiments of the present invention, the operation load of the engine may be predetermined by a rotation speed and fuel injection amount.

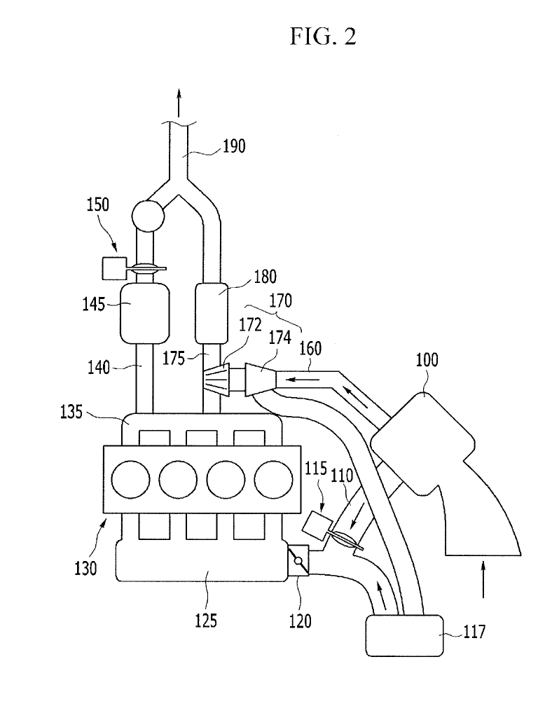

FIG. 2 is a schematic diagram illustrating an engine system having a turbocharger according to various embodiments of the present invention. Elements different from the elements illustrated in FIG. 1 will be described with reference to FIG. 2, but a description of elements that are the same or similar to the elements illustrated in FIG. 1 will be omitted.

Referring to FIG. 2, the third catalyst device 155 is disposed in the downstream side of the exhaust route control valve 150 provided in the main exhaust line 140, the exhaust gas flowing in the supplementary exhaust line 175 does not pass through the third catalyst device 155, and the exhaust gas is exhausted to the outside through the single exhaust line 190.

In various embodiments of the present invention, when the operation load of the engine 130 is less than the predetermined value, the exhaust route control valve 150 is closed, so the exhaust gas flows in the supplementary exhaust line 175.

Since the exhaust gas flows through the turbine 172 of the turbocharger 170, the second catalyst device 180, and the single exhaust line 190, back pressure of the downstream side of the turbine 172 is reduced and the turbine 172 quickly rotates the compressor 174.

When the operation load of the engine 130 is greater than the predetermined value, the exhaust route control valve 150 is closed. The exhaust gas flows in the main exhaust line 140 in a state which the exhaust route control valve 150 is opened.

The exhaust gas is exhausted to the outside by passing through the first catalyst device 145, the exhaust route control valve 150, the third catalyst device 155, and the single exhaust line 190.

In various embodiments of the present invention, an intake air is supplied to the combustion chamber of the engine 130 through the intake route control valve 115 without passing through the intercooler 117, and the exhaust gas exhausted from the combustion chamber is exhausted to the outside through the main exhaust line 140 and the single exhaust line 190, thus the turbocharger 170 is not operated in a state in which the exhaust route control valve 150 and the intake route control valve 115 are opened.

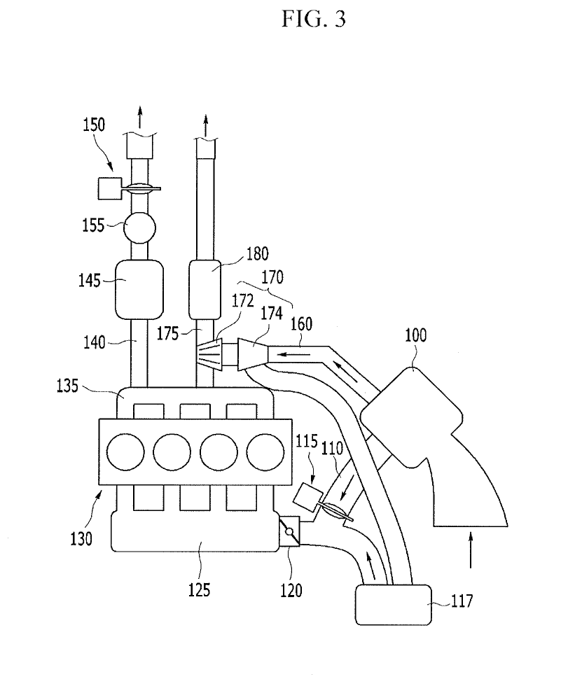

FIG. 3 is a schematic diagram illustrating an engine system having a turbocharger according to various embodiments of the present invention. Elements different from the elements illustrated in FIG. 1 will be described with reference to FIG. 3, but a description of elements that are the same or similar to the elements illustrated in FIG. 1 will be omitted.

Referring to FIG. 3, the third catalyst device 155 is disposed in the upstream side of the exhaust route control valve 150 provided in the main exhaust line 140. Since the supplementary exhaust line 175 and the main exhaust line are not joined, the exhaust gas flowing in the supplementary exhaust line 175 does not flow through the third catalyst device 155 and is exhausted to the outside.

Further, the exhaust gas flowing in the main exhaust line is directly exhausted to the outside without passing though the supplementary exhaust line.

In various embodiments of the present invention, when the operation load of the engine 130 is less than the predetermined value, the exhaust route control valve 150 is closed. The exhaust gas flows in the supplementary exhaust line 175 in a state in which the exhaust route control valve 150 is closed.

The exhaust gas is exhausted to the outside by passing through the turbine 172 of the turbocharger 170 and the second catalyst device 180. Therefore, back pressure of the downstream side of the turbine 172 is reduced and the turbine 172 quickly rotates the compressor 174.

When the operation load of the engine 130 is greater than the predetermined value, the exhaust route control valve 150 is closed. The exhaust gas flows in the main exhaust line 140 in a state in which the exhaust route control valve 150 is opened.

The exhaust gas is exhausted to the outside by passing through the first catalyst device 145, the third catalyst device 155, and the exhaust route control valve 150.

In various embodiments of the present invention, intake air is supplied to the combustion chamber of the engine 130 through the intake route control valve 115 without passing through the intercooler 117, and the exhaust gas exhausted from the combustion chamber is exhausted to the outside through the main exhaust line 140, thus the turbocharger 170 is not operated in a state in which the exhaust route control valve 150 and the intake route control valve 115 are opened.

According to various embodiments of the present invention, torque is increased in a low-speed range and fuel consumption is reduced by additionally injecting air by using a turbocharger at an rpm or less (low-speed range) set in the existing natural air intake type gasoline engine to improve fuel efficiency. Further, it is possible to maintain high torque in a high-speed range and increase torque in a low-speed range by using a small turbocharger through a natural air intake type.

That is, according to various embodiments of the present invention, since intake air is turbocharged by using the turbocharger in a low-speed range that is generally mainly used and the natural intake type is used in a high-speed range, it is possible to reduce capacity of the turbocharger, increase torque in a low-speed range, and reduce fuel consumption.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine system having a turbocharger, the system comprising:
a main exhaust line branched from a first side of an exhaust manifold and exhausting an exhaust gas from a combustion chamber;
a supplementary exhaust line branched from a second side of the exhaust manifold and exhausting the exhaust gas from the combustion chamber;
a first catalyst device disposed in the main exhaust line and reducing toxic material included in the exhaust gas;
a turbine of a turbocharger disposed in the supplementary exhaust line and operated by flow energy of the exhaust gas;
a second catalyst device disposed in a downstream side of the turbine and reducing toxic material included in the exhaust gas; and
an exhaust route control valve disposed in the main exhaust line and controlling a route of the exhaust gas.

2. The engine system of claim 1, wherein the exhaust route control valve is disposed in a downstream side of the first catalyst device.

3. The engine system of claim 2, wherein a third catalyst device is disposed in the downstream side of the first catalyst device.

4. The engine system of claim 1, wherein the main exhaust line and the supplementary exhaust line are joined and form a single exhaust line.

5. The engine system of claim 4, wherein a third catalyst device purifying the exhaust gas is disposed in the single exhaust line.

6. The engine system of claim 1, further comprising:
a main intake line supplying external air to an intake manifold;
a supplementary intake line branched from an upstream side of the main intake line and joined to a downstream side of the main intake line;
an intake route control valve disposed where the main intake line and the supplementary intake line are connected and controlling gas flowing in the main intake line;
a compressor of the turbocharger disposed in the supplementary intake line and operated by the turbine of the turbocharger; and
an intercooler disposed in a downstream side of the compressor of the turbocharger and cooling air compressed by the compressor.

7. The engine system of claim 6, wherein a throttle valve controlling gas supply to the intake manifold is disposed in an inlet of the intake manifold.

8. The engine system of claim 1, wherein the main exhaust line and the supplementary exhaust line are not joined and exhaust the exhaust gas to the outside, respectively.

9. The engine system of claim 1, wherein the exhaust route control valve is disposed in a downstream side of the first catalyst device.

10. The engine system of claim 9, wherein a third catalyst device purifying the exhaust gas is disposed between the exhaust route control valve and the first catalyst device of the main exhaust line.

11. The engine system of claim 10, wherein the main exhaust line and the supplementary exhaust line are connected to an outside, respectively, and exhaust the exhaust gas to the outside.
